(19) United States
(12) Patent Application Publication
(10) Pub. No.: US 2015/0325846 A1
(43) Pub. Date: Nov. 12, 2015

(54) ELECTRODE MATERIAL

(71) Applicant: SUMITOMO OSAKA CEMENT CO., LTD., Tokyo (JP)

(72) Inventors: Takao KITAGAWA, Tokyo (JP); Yoshitaka YAMAMOTO, Tokyo (JP)

(21) Appl. No.: 14/388,413

(22) PCT Filed: Mar. 7, 2013
(86) PCT No.: PCT/JP2013/056297

§ 371 Date: Sep. 26, 2014

(30) Foreign Application Priority Data
Mar. 30, 2012 (JP) 2012-078860

(51) Int. Cl. H01M 4/36; H01M 4/505; H01M 4/587; H01M 4/136; H01M 4/58; H01M 4/62; H01M 4/525; H01M 4/131

(52) U.S. Cl. CPC H01M 4/366; H01M 4/525; H01M 4/505; H01M 4/131; H01M 4/136; H01M 4/5825; H01M 4/622; H01M 4/587; H01M 2004/028

(57) ABSTRACT

An electrode material includes an aggregate which is formed by aggregating electrode active material particles having a carbonaceous film forced on the surface thereof, in which a volume density of the aggregate is 50% by volume or more and 80% by volume or less of the volume density of a solid body which has the same external appearance as the aggregate, a coverage ratio of the carbonaceous film with respect to the surface of the electrode active material particles is 80% or more, and an average thickness of the carbonaceous film is 1.0 nm or more and 7.0 nm or less.

### TECHNICAL FIELD

The present invention relates to an electrode material.

The present application claims priority based on Japanese Patent Application No. 2012-078860 filed on Mar. 30, 2012, the entire content of which is incorporated herein by reference in its entirety.

### BACKGROUND ART

In recent years, as a battery which is expected to achieved miniaturization, weight-saving and high capacity, a non-aqueous electrolyte-type secondary battery, such as a lithium ion battery, has been suggested and provided for practical uses. The lithium ion battery includes a positive electrode and a negative electrode, which have properties capable of reversibly deintercalating and intercalating lithium ions, and a non-aqueous electrolyte.

As a negative electrode material of a lithium ion battery, a Li-containing metal oxide having properties capable of reversibly deintercalating and intercalating lithium ions, such as a carbon-based material or a lithium titanium oxide (Li₄Ti₅O₁₂), is generally used as a negative electrode active material.

On the other hand, as a positive electrode material of a lithium ion battery, an electrode material mixture which includes a Li-containing metal oxide having properties capable of reversibly deintercalating and intercalating lithium ions as a positive electrode active material, such as lithium iron phosphate (LiFePO₄), a binder and the like is used. In addition, a positive electrode of a lithium ion battery is formed by applying the electrode material mixture to the surface of a metal foil, called a current collector.

Compared with secondary batteries in the related art, such as lead batteries, nickel cadmium batteries, nickel hydrogen batteries and the like, such lithium ion batteries described above are light in weight and small in size, and also, have a high amount of energy. Accordingly, the lithium ion batteries are used as a small power supply used for portable electronic devices, such as mobile phones and notebook-type personal computers and also used as a large stationary type emergency power supply.

In addition, recently, lithium ion batteries have been studied as a high output power supply for plug-in hybrid vehicles, hybrid vehicles, electric power tools and the like. In order to be used as a high output power supply for the above-mentioned vehicles and tools, the batteries need to have high speed charge and discharge characteristics.

However, an electrode material including an electrode active material, for example, an electrode material including a lithium phosphate compound having properties capable of reversibly deintercalating and intercalating lithium ions has a problem or low electron conductivity.

In order to improve the electron conductivity of an electrode material, there is suggested an electrode material in which a surface of electrode active material particles is covered with an organic compound that is a carbon source, the organic compound is then carbonized to form a carbonaceous film on the surface of the electrode active material particles, that is, carbon of the carbonaceous film is interposed as an electron conductive material (refer to Patent Literature 1).

### CITATION LIST

### Patent Literature

Patent Literature: Japanese Laid-open Patent Publication No. 2001-15111

### SUMMARY OF THE INVENTION

### Problem to be Solved by the Invention

In order to use the electrode active material including a lithium phosphate compound as an electrode material of a lithium ion battery used for a high output power supply, a carbonaceous film is preferably formed on the surface of the electrode active material particle to increase electron conductivity.

On the other hand, the carbonaceous film is an obstacle when lithium ions are diffused. That is, the larger the thickness of the carbonaceous film is, and the higher the crystallinity of the carbonaceous film is, the more the conductivity of lithium ions deteriorates. As a result, the internal resistance of the battery increases due to the carbonaceous film, and particularly when high speed charge and discharge is performed, the voltage drops significantly.

In addition, when the thickness of the carbonaceous film is uneven, sites where electron conductivity is low are locally formed in a positive electrode. As a result, for example, when the battery is used for a large stationary type emergency power supply, and particularly, is used at a low temperature, there is a problem of the capacity decreasing depending on a voltage drop at the final stage of discharge.

For the purpose for reducing unevenness in a carbonaceous film of an electrode active material, the present inventors have suggested an electrode material which can reduce unevenness in a carbonaceous film of an electrode active material. The electrode material is formed as an aggregate having an average particle size of 0.5 μm or more and 100 μm or less by aggregating electrode active material particles having a carbonaceous film formed on the surface thereof, and a volume density of the aggregate is set to 50% by volume or more and 80% by volume or less of the volume density of a solid body which has the same external appearance as the aggregate. (Japanese Patent Application No. 2010-282353). However, even in the electrode material, the electron conductivity was improved, but sufficient lithium ion conductivity was not able to be achieved.

As described above, application of a lithium phosphate compound to a high output power supply has been limited up to now. In order to facilitate high speed charge and discharge characteristics of a lithium phosphate compound, further improvements have been required, such as, farther addition of a fibrous conductive carbon, mixing with a spinel type positive electrode material or a layered oxide excellent in high speed charge and discharge characteristics, or the like. However, even when these materials are added, there has still been a problem of deterioration in lithium ion conductivity.

The present invention has been made to solve the above problems. An object thereof is to provide an electrode material which is capable of improving both electron conductivity and lithium ion conductivity by controlling the density and crystallinity of the carbonaceous film and the thickness of the carbonaceous film, when an electrode active material having a carbonaceous film formed on the surface thereof is used as an electrode material.

### Means for Solving the Problems

As a result of thorough studies to solve the above problems, the present inventors have found that, when a volume density of an aggregate which is formed by aggregating electrode active material particles having a carbonaceous film formed on the surface of the particles is set to 50% by volume or more and 80% by volume or less of the volume density of a solid body which has the same external appearance as the aggregate, a coverage ratio of the carbonaceous film with respect to the surface of the electrode active material particles is set to 80% or more, and an average thickness of the carbonaceous film is set to 1.0 nm or more and 7.0 nm or less, electron conductivity is improved without deterioration in lithium ion conductivity, and thus, it is possible to realize a lithium phosphate compound having electron conductivity and lithium ion conductivity satisfying high speed charge and discharge characteristics. In this way, the present invention has been accomplished.

That is, an electrode material of the present invention includes an aggregate which is formed by aggregating electrode active material particles having a carbonaceous film formed on the surface thereof, in which a volume density of the aggregate is 50% by volume or more and 80% by volume or less of the volume density of a solid body which has the same external appearance as the aggregate, a coverage ratio of the carbonaceous film with respect to the surface of the electrode active material particles is 80% or more, and an average thickness of the carbonaceous film is 1.0 nm or more and 7.0 nm or less.

It is preferable that a mass of carbon in the carbonaceous film be 0.6% by mass or more and 2.0% by mass or less with respect to a mass of the electrode active material particles, and a specific surface area of the electrode active material particles having the carbonaceous film formed on the surface thereof be 5 m²/g or more and 20 m²/g or less.

It is preferable that a mass of a carbon component in the carbonaceous film be 50% by mass or more with respect to a total mass of the carbonaceous film, and a density obtained from the carbon component in the carbonaceous film be 0.3 g/cm³ or more and 1.5 g/cm³ or less.

It is preferable that the electrode active material particles contain one kind selected from the group consisting of lithium cobaltate, lithium nickelate, lithium manganate, lithium titanate, and LiₓA_{y}D_{z}PO₄ (provided that, A is one or two or more kinds selected from the group consisting of Co, Mn, Ni, Fe, Cu, and Cr, D is one or two or more kinds selected from the group consisting of Mg, Ca, S, Sr, Ba, Ti, Zn, B, Al, Ga, In, Si, Ge, Sc, Y, and rare earth elements 0<x<2, 0<y<1.5, and 0≦z<1.5) as a main component.

### Effects of Invention

The electrode material of the present invention includes the aggregate which is formed by aggregating the electrode active material particles having the carbonaceous film on the surface thereof, and when the volume density of a solid body which has the same external appearance as the aggregate is set to 100% by volume, the volume density of the aggregate is 50% by volume or more and 80% by volume or less, the coverage ratio of the carbonaceous film with respect to the surface of the electrode active material particles is 80% or more, and the average thickness of the carbonaceous film is 1.0 nm or more and 7.0 nm or less. Thus, unevenness in an amount of the carbonaceous film formed on the surface of the electrode active material particles can be reduced, and electron conductivity can be improved without deterioration in lithium ion conductivity. Accordingly, when the electrode active material is used as a positive electrode of a lithium ion battery, the internal resistance of the battery can be reduced and as a result, high speed charge and discharge can be performed without a concern of a significant voltage drop.

In addition, unlike a conventional technology, high speed charge and discharge can be facilitated, without the addition of the conductive fibrous carbon and without the addition of a layered oxide or a spinel type positive electrode material which are excellent in high speed charge and discharge characteristics. Accordingly, the electrode material of the present indention can be applied to a high output power supply in which high speed charge and discharge is required.

Further, since the volume density of the aggregate formed by aggregating the electrode active material particles having the carbonaceous film formed on the surface is set to 50% by volume or more and 80% by volume or less of the volume density of a solid body which has the same external appearance as the aggregate, unevenness in the amount of the carbonaceous film formed on the surface of the electrode active material particles can be reduced, and thus, unevenness in the electron conductivity of the electrode active material can be reduced. Accordingly, when the electrode active material in which unevenness in the electron conductivity is reduced is used as the electrode material of the lithium ion battery, a reaction related to deintercalation and intercalation of lithium ions can be uniformly carried out on the entire surface of the electrode active material, and thus, the internal resistance of the electrode can be reduced.

### BEST MODE FOR CARRYING OUT THE INVENTION

The present invention relates to an electrode material. The present invention particularly relates to an electrode material which is used for a positive electrode material for a battery, and more particularly which is suitably used for a positive electrode material for a lithium ion battery.

An embodiment for carrying out the electrode material of the present invention will be described below.

The embodiment will be specifically described in order to facilitate a better understanding of the gist of the invention. However, the present invention is not limited thereto unless otherwise specified. Pumpers, amounts, kinds, and ratios may be omitted and/or changed within a range not departing from the scope of the invention unless any particular problem arises.

[Electrode Material]

An electrode material of this embodiment includes an aggregate formed by aggregating electrode active material particles having a carbonaceous film formed on the surface thereof. That is, the electrode material is composed of one or more aggregates. A volume density of the aggregate is 50% by volume or more and 80% by volume or less of the volume density of a solid body which has the same external appearance as the aggregate. A coverage ratio of the carbonaceous film with respect to the surface of the electrode active material particles is 80% or more, and an average thickness of the carbonaceous film is 1.0 nm or more and 7.0 nm or less. The carbonaceous film is a film which is generated by thermally decomposing an organic compound, is disposed on the electrode active material, and connected between the electrode active materials.

Here, the aggregate which is formed by aggregating the electrode active material particles having the carbonaceous film formed on the surface thereof means that the electrode active material particles having tire carbonaceous film forced on the surface thereof are aggregated in a point contact state. That is, it means that a contact portion of the electrode active material particles has a need shape which has a small cross-sectional area, and thus, due to such a shape, the aggregate includes the electrode active material particles which are strongly connected to each other. In this manner, since the contact portion formed between the electrode active material particles has a need shape having a small cross-sectional area, the structure is formed in the aggregate wherein channel-shaped (network-shaped) voids are three-dimensionally expanded. Here, the neck shape refers to a shape which has a narrower cross-sectional area than that of a head portion (particle itself).

The volume density of the aggregate can be measured using a mercury porosimeter. The volume density of the aggregate is a value calculated from a total mass of the electrode material composed of the aggregate with the volume of a gap between the particles which form the aggregate, wherein the gap is obtained by excluding the volume of the electrode active material particles and a gap between the aggregates from the total volume. In other words, the volume density of the aggregate is the aggregate density obtained by calculation using a total mass of the electrode material, which is composed of the aggregate, and a particle gap formed in the aggregate, wherein the gap is obtained by excluding the volume of the electrode active material particles and the volume of the gap formed between the aggregates from the total volume of an assembly of the aggregates.

The volume density of the aggregate is preferably 50% by volume or more and 80% by volume or less, more preferably is 55% by volume or more and 75% by volume or less, and still more preferably 60% by volume or more and 75% by volume or less, when the volume density of a solid body which has the same external appearance as the aggregate is set to 100% by mass, that is, when it is assumed that the aggregate has no void and the volume density of the aggregate is 100% by mass.

Here, such an aggregate which is a solid body refers to an aggregate in which a void is not present at all, and the density of the solid aggregate refers to the density that is the same as a theoretical density of an electrode active material.

In this manner, when the volume density of the aggregate is set to 50% by volume or more and 80% by volume or less, the aggregate that is densified in a state in which the aggregate has a predetermined quantity of pores (voids) can be used. Thus, the strength of the entire aggregate can increase while the aggregate has voids. For example, when the electrode active material is mixed with a binder, a conductive assistant, and a solvent to prepare electrode slurry, the aggregate is not likely to collapse. As a result, an increase in the viscosity of the electrode slurry is suppressed, and flowability is maintained. Accordingly, coating properties are improved, and filling properties of the electrode active material in a coated film of the electrode slurry are also improved.

Here, when the volume density of the aggregate is out of the above range, for example, when the volume density of the aggregate is less than 50% by volume of the volume density of a solid body which has the same external appearance as the aggregate, the void portions may be too increased and a concentration of vapor of an aromatic carbon compound in the pores inside the aggregate of the electrode active material may become too low. Here, the aromatic carbon compound is an intermediate product generated when an organic compound is carbonized. The aromatic carbon compound is generated by thermal decomposition of the organic compound, the aromatic carbon compound is then condensation-polymerized by heating, and thus, a carbonaceous film is formed. When the concentration of the vapor becomes excessively low, the thickness of the carbonaceous film becomes thin at the center portion of the aggregate and the internal resistance of the electrode active material increases, and thus, such a case is not preferable. On the other hand, when the volume density of the aggregate exceeds 80% by volume of the volume density of a solid body which has the same external appearance as the aggregate, the void portions may be too decreased, that is, the density in the aggregate may too increase, and channel-shaped (network-shaped) pores inside the aggregate may decrease. As a result, a tar-like material, which is generated during carbonization of the organic compound, may be trapped inside the aggregate, and thus this range is not preferable.

The electrode active material which forms the electrode active material particles can be arbitrarily selected. It is preferable that the electrode active material contain one kind selected from the group consisting of lithium cobaltate, lithium nickelate, lithium manganate, lithium titanate, and LiₓA_{y}D_{z}PO₄ (provided that, A is one or two or more kinds selected from the group consisting of Co, Mn, Ni, Fe, Cu, and Cr, D is one or two or more kinds selected from the group consisting of Mg, Ca, S, Sr, Ba, Ti, Zn, B, Al, Ga, In, Si, Ge, Sc, Y, and rare earth elements, 0<x2, 0<y<1.5, and 0≦z<1.5) as a main component.

Here, from the viewpoints of a high discharge potential, abundant resources, safety and the like, A is preferably selected from Co, Mn, Ni, and Fe, and D is preferably selected from Mg, Ca, Sr, Ba, Ti, Zn, and Al.

Here, the rare earth elements refer to 15 elements of La, Ce, Pr, Nd, Pm, Sm, Eu, Gd, Tb, Dy, Ho, Er, Tm, Yb, and Lu that belong to lanthanide series.

When the electrode active material of the present invention is used as the electrode material of the lithium ion battery, a reaction which is related to deintercalation and intercalation of lithium ions is uniformly carried out on the entire surface of the electrode active material. Thus, preferably 80% or more, more preferably 85% or more, and still more preferably 90% or more, of the surface of the electrode active material particles is covered with the carbonaceous film.

The coverage rate of the carbonaceous film can be measured using a transmission electron microscope (TEM), and an energy dispersive X-ray spectrometer (EDX). Specifically, the coverage rate of the carbonaceous film formed on the electrode active material particles is obtained by observing 100 electrode active material particles using a transmission electron microscope (TEM), and an energy dispersive X-ray spectrometer (EDX), and calculating a ratio of a portion, which is covered with the carbonaceous film, with respect to the surface of the electrode active material particles.

When the coverage rate of the carbonaceous film is less than 80%, the covering effect of the carbonaceous film is not sufficient. Therefore, when the deintercalation and intercalation reaction of lithium ions is carried out on the surface of the electrode active material, reaction resistance union is related to the deintercalation and intercalation of lithium ions may increase at a site where the carbonaceous film is not formed, and thus, a voltage drop at a final stage or discharge may become significant, and therefore, such a range is not preferable. The upper limit of the coverage rate or the surface of the electrode active material particles, which is covered with the carbonaceous film, can be arbitrarily selected, and for example, the upper limit can be set to 100%, that is, the upper limit of the range can be set to 100% or less. For example, the upper limit can be selected from 98% or less, 96% or less, 93% or less, 90% or less, or the like as required.

A mass of carbon in the carbonaceous film of the present invention can be selected as required. The mass of carbon is preferably 0.6% by mass or more and 2.0% by mass or less, preferably 0.8% by mass or more and 1.9% by mass or less, and still more preferably 1.1% by mass or more and 1.7% by mass or less with respect to the mass of the electrode active material particles (100% by mass). A mass fraction of the carbon component in the carbonaceous film can be obtained by weighing the obtained electrode material, immersing the material in an acidic aqueous solution to separate only the carbonaceous film as a residue which is obtained after dissolution, and then, measuring a carbon fraction of the carbonaceous film using a carbon analyzer.

Here, the reason why the mass of carbon in the carbonaceous film is limited to the above range is as follows. When as amount of carbon is less than 0.6% by mass, a discharge capacity may decrease at a high speed charge and discharge rate when a battery is formed, and as a result, it may be difficult to realize sufficient charge and discharge rate performance. On the other hand, when the amount of carbon exceeds 2.0% by mass, lithium ion transfer resistance increases due to a steric hindrance during diffusion of lithium ions in the carbonaceous film, and as a result, the internal resistance of the battery may increase and a voltage drop may be significant when a high speed charge and discharge rate is used.

The average thickness of the carbonaceous film of the present invention is preferably 1.0 nm or more and 7.0 nm or less, more preferably 2.0 nm or more and 6.0 nm or less, and still more preferably 3.0 nm or more and 5.0 nm or less. The thickness can be calculated based on a transmission electron microscope (TEM) electronography obtained by observing the carbonaceous film on the surface of the electrode material using a transmission electron microscope (TEM).

Here, the reason why the average thickness of the carbonaceous film is limited to the above range is as follows. When the average thickness is less than 1.0 nm, charge transfer resistance in the carbonaceous film increases, and as a result, the internal resistance or the battery may increase, and a voltage drop at high speed charge and discharge rate may be significant. On the hand, when the average thickness of the carbonaceous film exceeds 7.0 nm, lithium ion transfer resistance increases due to a steric hindrance during diffusion of lithium ions in the carbonaceous film, and as a result, the internal resistance of the battery may increase and a voltage drop may be significant when a high speed charge and discharge rate is used.

Here, the “internal resistance” used herein refers to resistance obtained by mainly adding charge transfer resistance to lithium ion transfer resistance. The charge transfer resistance is proportional to the thickness of the carbonaceous film, and the density and crystallinity of the carbonaceous film, and the lithium ion transfer resistance is inversely proportional to the thickness of the carbonaceous film, and the density and crystallinity of the carbonaceous film.

As a method of evaluating the internal resistance, for example, a current rest method or the like can be used. In the current rest method, the internal resistance is measured as the sum of wiring resistance, contact resistance, charge transfer resistance, lithium ion transfer resistance, lithium reaction resistance in a positive electrode and a negative electrode, interelectrode resistance determined by a distance between a positive electrode and a negative electrode, resistance associated with lithium ion solvation and desolvation, and lithium ion transfer resistance, at a solid electrolyte interface (SEI).

The mass of the carbon component in the carbonaceous film of the electrode material of the present invention is preferably 50% by mass or more, and more preferably 60% by mass or more with respect to the total mass of the carbonaceous film. The upper limit thereof can be arbitrarily selected. However, for example, the upper limit may be set to 100% by mass, that is, the upper limit of the range may be set to 100% by mass or less. Other examples of the upper limit include 95% by mass or less, 90% by mass or less, 85% by mass or less, or 80% by mass or less.

Here, the reason why the mass of the carbon component in the carbonaceous film is limited to the above range is as follows. When the mass of the carbon component in the obtained carbonaceous film is less than 50% by mass, the charge transfer resistance of the carbonaceous film increases, and as a result, the internal resistance of the battery may increase and a voltage drop may be significant when a high speed charge and discharge rate is used.

The carbonaceous film of the electrode material is generated by thermally decomposing an organic compound which is a precursor of carbon. Accordingly, the carbonaceous film inevitably includes an element such as hydrogen and oxygen in addition to carbon. Thus, for example, when baking is performed at a temperature in a range of 500° C. or lower, the mass of the carbon component in the obtained carbonaceous film may be less than 50% by mass. In this case, the charge transfer resistance of the carbonaceous film increases, and as a result, the internal resistance of the battery may increase and a voltage drop may be significant when a high speed charge and discharge rate is used.

The density obtained from the carbon component in the carbonaceous film of the present invention is preferably 0.3 g/cm³ or more and 1.5 g/cm³ or less, and more preferably 0.35 g/cm³ or more and 1.3 g/cm³ or less, and more preferably 0.4 g/cm³ or more and 1.0 g/cm³ or less. The density can be measured using the separated carbonaceous film and a dry type density meter.

Here, the reason why the density obtained from the carbon component in the carbonaceous film is limited to the above range is as follows. When the density is less than 0.3 g/cm³, the electron conductivity of the carbonaceous film may be insufficient. On the other hand, when the density exceeds 1.5 g/cm³, a large number of microcrystals of graphite having a layered structure may be generated in the carbonaceous film. Then, when the lithium ions are diffused in the carbonaceous film, the microcrystals of graphite causes a steric hindrance and lithium ion transfer resistance increases, and as a result, the internal resistance of the battery may increase and a voltage drop may be significant when a high speed charge and discharge rate is used.

A specific surface area of the electrode active material particles which has the carbonaceous film formed on the surface thereof is preferably 5 m²/g or more and 20 m²/g or less, more preferably 7 m²/g or more and 16 m²/g or less, and still more preferably 9 m²/g or more and 13 m²/g or less. The specific surface area can be obtained by measuring the electrode material using a specific surface area meter.

Here, the reason why the specific surface area of the electrode active material particles having the carbonaceous film formed on the surface thereof is limited to the above range is as follows. When the specific surface area is less than 3 m²/g, the average thickness of the carbonaceous film may exceed 7 nm in a case in which the amount of carbon in the carbonaceous film is 2.0% by mass or more. On the other hand, when the specific surface area exceeds 20 m²/g, the average thickness of the carbonaceous film may be less than 1.0 nm in a case in which the amount of carbon in the carbonaceous film is less than 0.6% by mass. That is, when the specific surface area is out of the above range, an appropriate carbon amount may not be maintained.

[Method of Producing Electrode Material]

A preferable method of producing an electrode material of the present invention is described as follows. In the method of producing the electrode material of the embodiment, slurry which includes an electrode active material or a precursor thereof, an organic compound, and water and is obtained by mixing these components is prepared. In the slurry, it is preferable that, with regard to the particle diameter distribution of the electrode active material or the precursor thereof, a ratio of D90 to D10 (D90/D10) is 5 or more and 30 or less, and more preferably 10 to 25. Here, D90 represents a particle diameter when a volume accumulation percentage in the particle diameter distribution is 90%, and D10 represents a particle diameter when the volume accumulation percentage in the particle diameter distribution is 10%. When the value is within the above range, it is advantageous in that the volume density of the aggregate can be desirably controlled. Then, the slurry is dried. Next, the dried product is baked at 500° C. or higher and 1000° C. or lower in a non-oxidizing atmosphere.

The particle diameter and the particle diameter distribution of the electrode active material or the precursor thereof can be measured using a particle size distribution analyzer or the like.

The electrode active material can be arbitrarily selected. Similar to the examples described in the aforementioned explanation of the electrode material, it is preferable that the electrode active material includes one kind selected from the group consisting of lithium, cobaltate, lithium nickelate, lithium manganate, lithium titanate, and LiₓA_{y}D_{z}PO₄ (provided that, A is one or two or more kinds selected from the group consisting of Co, Mn, Ni, Fe, Cu, and Cr, D is one or two or more kinds selected from the group consisting of Mg, Ce, S, Sr, Ba, Ti, Zn, B, Al, Ga, In, Si, Ge, Sc, Y, and rare earth elements, 0<x<2, 0<y<1.5, and 0≦z<1.5) as a main component.

Here, from the viewpoints of a high discharge potential, abundant resources, safety and the like, A is preferably selected from Co, Mn, Ni, and Fe and D is preferably selected from Mg, Ca, Sr, Ba, Ti, Zn, and Al.

Here, the rare earth elements refer to 15 elements of La, Ce, Pr, Nd, Pm, Sm, Eu, Gd, Tb, Dy, Ho, Er, Tm, Yb, and Lu that belong to lanthanide series.

As a compound (LiₓA_{y}D_{z}PO₄ powder) represented by LiₓA_{y}D_{z}PO₄, a compound, which is produced by in the conventional method such as a solid phase method, a liquid phase method, and a vapor phase method or the like, can be used.

The compound (LiₓA_{y}D_{z}PO₄ powder) can be arbitrarily selected. For example, a compound (LiₓA_{y}D_{z}PO₄ powder) can be suitably used which is obtained such that hydrothermal synthesis is performed for a slurry mixture, which is obtained by mixing a Li source, bivalent iron salts, phosphate compounds and water, using a pressure-resistant airtight container, the precipitate obtained the synthesis is washed with water to generate a cake-like precursor material, and cake-like precursor material is baked to obtain the compound.

Specifically, a slurry mixture is prepared, which is obtained by mixing a Li source selected from the group consisting of lithium salts such as lithium acetate (LiCH₃COO) and lithium chloride (LiCl) or lithium hydroxide (LiOH), bivalent iron salts such as iron (II) chloride (FeCl₂), iron (II) acetate (Fe(CH₃COO)_{z}) and iron (II) sulfate (FeSO₄), a phosphoric acid compound such as phosphoric acid (H₃PO₄), ammonium dihydrogen phosphate (NH₄H₂PO₄) and diammonium hydrogen phosphate ((NH₄)₂HPO₄), and water; and then, the slurry mixture is subjected to the above synthesis and treatment to obtain a compound (LiₓA_{y}D_{z}PO₄ powder) (0<x<2, 0<y<1.5, and 0≦z<1.5), and the compound can be suitably used.

The LiₓA_{y}D_{z}PO₄ powder may be a crystalline particle, an amorphous particle, or a mixed crystal particle in which a crystalline particle and an amorphous particle coexist. Here, the reason why the LiₓA_{y}D₂PO₄ powder may be an amorphous particle is that, when the amorphous LiₓA_{y}D_{z}PO₄ powder is thermally treated in a non-oxidizing atmosphere at a temperature of 500° C. or higher and 1000° C. or lower, the powder is crystallized.

The size of the electrode active material of the present invention is not particularly limited, but the average particle diameter of primary particles is preferably 0.1 μm or more and 20 μm or less, more preferably 0.01 μm or more and 12 μm or less, and still more preferably 0.02 μm or more and 5 μm or less. The above particle diameter is a volume average particle diameter.

Here, the reason why the average particle diameter of the primary particles of the electrode active material is limited to the above range is as follows. When the average particle diameter of the primary particles is less than 0.01 μm, it is difficult to sufficiently cover the surface of each of the primary particles with a thin film-like carbon, and thus, a discharge capacity may become low at a high speed charge and discharge rates. As a result, it may be difficult to realize a sufficient charge and discharge rate performance, and is not preferable. On the other hand, when the average particle diameter of the primary particles exceeds 20 μm, the internal resistance of the primary particles may increase, and thus, the discharge capacity at a high speed charge and discharge rate may become insufficient, and therefore it is not preferable.

The shape of the electrode active material of the present invention is not particularly limited. However, from the viewpoints that an electrode material constituted by secondary particles having a spherical shape, particularly, a real spherical shape may be easily generated, it is preferable that the shape of the electrode active material be a spherical shape, particularly a real spherical shape. The shape of the electrode active material can be determined using a scanning electron microscope (SEM). That is, for example, shape of the electrode active material can be determined by photographing.

Here, the reason why it is preferable that the shape of the electrode active material be a spherical shape is as follows. When preparing a paste for a positive electrode by mixing an electrode active material, a binder resin (binding agent), and a solvent, an amount of solvent can be reduced, and the paste for the positive electrode can be easily coated on a current collector.

In addition, when the shape of the electrode active material is a spherical shape, a surface area of the electrode active material becomes to be the minimum, and thus a mixing amount of the binder resin (binding agent) that is added to an electrode material mixture can be a minimum amount. Accordingly, the internal resistance of the obtained positive electrode can be made small, and tins this shape is preferable.

Furthermore, since the electrode active material can be easily closely packed, a filled amount of the positive material per unit volume can be increased. Accordingly, an electrode density can be increased. As a result, high capacity of the lithium ion battery may be realized, and thus this shape is preferable.

The organic compound used in the formation of carbonaceous film can be arbitrarily selected. Examples thereof include polyvinyl alcohol, polyvinyl pyrrolidone, cellulose, starch, gelatin, carboxymethyl cellulose, methyl cellulose, hydroxymethyl cellulose, hydroethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, dihydric alcohols, and trihydric alcohols. These compounds may be used singly or in combination of two or more kinds thereof. Among these, polyvinyl alcohol, carboxymethyl cellulose, polyacrylic acid, glucose, fructose, and lactose are preferable.

When a total amount of the organic compound is converted into the amount of carbon, a blending ratio of the electrode active material and the organic compound is preferably 0.6 parts by mass or more and 2.0 parts by mass or less, more preferably 0.8 parts by mass or more and 1.8 parts by mass or less, and still more preferably 1.1 parts by mass or more and 1.7 parts by mass or less with respect to 100 parts by mass of the electrode active material.

Here, when the blending ratio of the organic compound in terms of the amount of carbon is less than 0.6 parts by mass, a discharge capacity at a high speed charge and discharge rate may decrease when a battery is formed, and thus, it may be difficult to realize sufficient charge and discharge rate performance. On the other hand, when the blending ratio of the organic compound, in terms of the amount of carbon exceeds 2.0 parts by mass, the average thickness or the carbonaceous film exceeds 7 nm, lithium ion transfer resistance tends to increase due to a steric hindrance during diffusion of lithium ions in the carbonaceous film. As a result, the internal resistance of the battery may increase when the battery is formed, and a voltage drop at a high speed charge and discharge rate may be significant.

The electrode active material and organic compound are dissolved or dispersed in water to prepare uniform slurry. At the time of the dissolution or dispersion, a dispersant may be added as required.

A method of dissolving or diffusing the electrode active material and the organic compound in water is not particularly limited as long as the electrode active material is diffused and the organic compound is dissolved or diffused. For example, a medium stirring type dispersing apparatus such as a planetary ball mill, a vibration ball mill, a bead mill, a painter shaker, or an attritor that stirs medium particles at a high speed is preferably used.

During the dissolution or dispersion, it is preferable to perform the stirring in such a manner that the electrode active material is dispersed as a primary particle in water, and then, the organic compound is added and dissolved. In this manner, a surface of the primary particle of the electrode active material is coveted with the organic compound. As a result, carbon originating from the organic compound can be uniformly interposed between primary particles of the electrode active material.

When the slurry is prepared, it is preferable that the dispersion condition of the slurry be adjusted such that a ratio (D90/D10) of the electrode active material or a precursor thereof is 5 or more and 30 or less. For example, by appropriately adjusting a concentration, a stirring time and the like of the electrode active material and the organic compound included in the slurry, the volume density of the obtained aggregate can be adjusted to 50% by volume or more and 60% by volume or less, when the volume density of a solid body which has the same external appearance as the aggregate is set to 100% by volume. Accordingly, a concentration of a vaporized material of an aromatic carbon compound inside the aggregate can be increased, and as a result, a carbonaceous film in which unevenness in the thickness thereof is reduced can be formed on the surface of the electrode active material in the aggregate. The vaporized material of the aromatic carbon compound inside the aggregate refers to a vaporized material of a compound having an aromatic ring composed of olefin generated by a C—C single bond cleavage due to heating the organic compound in an inert gas atmosphere, and is a gaseous material resulting from the organic compound wherein the material is generated daring the baking at 400° C. to 500° C.

Further, it is preferable that a concentration of the electrode active material and the organic compound included in the slurry, a stirring time and the like be appropriately adjusted. Due to the adjustment, the specific surface area of the electrode active material particles having the carbonaceous film formed on the surface thereof is controlled to have an arbitrary value within a range of preferably 5 m²/g or more and 20 m²/g or less, more preferably 7 m²/g or more and 17 m²/g or less, and still more preferably 9 m²/g or more and 13 m²/g or less.

The concentration of the electrode active material and the organic correspond in the slurry can be arbitrarily selected. For example, a solid content of the slurry is 20% by mass to 70% by mass, and preferably 30% by mass to 60% by mass. The stirring time can be arbitrarily selected, and for example, the stirring may be performed for 20 minutes to 7000 minutes, and preferably 30 minutes to 4000 minutes.

Next, the obtained slurry is sprayed and dried in the air and in a high temperature atmosphere, for example, 70° C. or higher and 250° C. or lower. A temperature range of the high temperature atmosphere may be arbitrarily selected, and for example, ranges of 90° C. or higher and 220° C. or lower, 100° C. or higher and 200° C. or lower, and 80° C. or higher and 190° C. or lower, can be preferably selected as required.

Next, the dried product is baked in a non-oxidizing atmosphere. For example, the dried product is baked at a temperature within a range of 500° C. or higher and 1000° C. or lower, preferably 550° C. or higher and 950° C. or lower, and more preferably 600° C. or higher and 900° C. or lower, for 0.1 hours or more and 40 hours or less. The baking temperature can be arbitrarily selected and is preferably within a range of 700° C. or higher and 1000° C. or lower. A baking time can be also arbitrarily selected and, for example, 0.5 hours or more and 15 hours or less, or 0.5 hours or more and 3 hours or less is preferably used.

As the non-oxidizing atmosphere, an inert atmosphere of nitrogen (N₂), argon (Ar), or the like is preferable. When it is desired to further suppress oxidation, a reducing atmosphere containing about several % by volume of a reducing gas such as hydrogen (H₂) in the inert atmosphere is preferably used. In addition, a burnable or combustible gas each as oxygen (O₂) may be introduced to the inert atmosphere to remove the organic component that is vaporized in the non-oxidizing atmosphere during the baking.

The reason why the baking temperature of the dried product is set to 500° C. or higher and 1000° C. or lower is described below. When the baking temperature is lower than 500° C., the decomposition and reaction of the organic compound included in the dried product does not progress sufficiently, and thus, carbonization of the organic compound tends to be insufficient. As a result, a high-resistance decomposed product of the organic compound may be generated in the obtained aggregate, and thus, such a product is not preferable. On the other hand, when the baking temperature exceeds 1000° C., Li in the electrode active material is evaporated, and a compositional deviation tends to occur in the electrode active material and grain growth of the electrode active material tends to be promoted. As a result, a discharge capacity at a high speed charge and discharge rate may decrease, and thus, it may be difficult to realize a sufficient charge and discharge rate performance, and a result is not preferable.

In the baking step, the particle else distribution of the obtained aggregate can be controlled by appropriately adjusting the conditions at the time of baking the dried product, for example, a temperature rising rate, the maximum holding temperature, a hold time, and the like.

By the above-described step, the surface of the primary particles of the electrode active material is covered with carbon that is generated by thermally decomposing the organic compound in the dried product. Thus, an aggregate which consists of a secondary particle in which carbon is interposed between the primary particles of the electrode active material may be obtained. That is, the plural primary particles bonded by a carbonaceous material are included in the secondary particle.

This aggregate is used as the electrode material of the embodiment. Plural aggregates are included in the electrode material. The size of the aggregate can be arbitrarily selected, and for example, the average particle sire is preferably 0.05 μm to 100 μm, more preferably 0.1 μm to 50 μm, and still more preferably 1.0 μm to 20 μm. The size can be determined by an electrophotograph photographed by a scanning electron microscope.

[Electrode]

An electrode of this embodiment is an electrode containing the electrode material of the embodiment.

An example of preparing the electrode of the embodiment will be described below. First, the above electrode material, a binding agent which is a binder resin and a solvent are mixed to prepare a coating material for electrode formation or a paste for electrode formation. At this time, a conductive auxiliary agent such an carbon black may be added as required.

The above binding agent, that is, the binder resin can be arbitrarily selected. For example, a polytetrafluoroethylene (PTFE) resin, a polyvinylidene fluoride (PVdF) resin, fluororubber or the like are suitable used.

A blending ratio of the electrode material and the binder resin is not particularly limited. For example, the binder rein can be mixed at a ratio of 1 part by mass or more and 30 parts by mass or less, and preferably 3 parts by mass or more and 20 parts by mass or less with respect to 100 parts by mass of the electrode material.

A solvent used in the coating material for electrode formation or the paste for electrode formation can be arbitrarily selected. Specific examples thereof include water, alcohols snob an methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol, monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether, ketones such as acetone, methyl, ethyl ketone (MEK), methyl isobutyl ketone (MIBK), acetylacetone, and cyclohexanone, amides such as dimethylformamide, N,N-dimethylacetoacetamide, and N-methylpyrrolidone, glycols such as ethylene glycol, diethylene glycol, and propylene glycol, and the like. These may be used alone or may be used in combination of two or more kinds thereof.

Next, the coating material for electrode formation or the paste for electrode formation is applied to one surface of a member of moral or the like, such as a metallic foil, which is arbitrarily selected. Then, the metallic foil is obtained, in which a coating film which is composed of a mixture of the electrode material and the binder resin is formed on one surface thereof by drying of the applied coating or paste.

Next, the coating film is pressure-joined to the member and dried to prepare a current collector (electrode) having an electrode material layer formed one surface of the metallic foil.

In this manner, it is possible to prepare the electrode capable of improving electron conductivity without deterioration in lithium ion conductivity obtained in the embodiment.

In the present invention, it is possible to obtain a lithium ion battery in which the current collector (electrode) is used as a positive electrode.

In the lithium ion battery, the internal resistance of the current collector (electrode) can be reduced by preparing the current collector (electrode) using the electrode material of the embodiment. Accordingly, the internal resistance of the battery can be reduced, and as a result, it is possible to provide a lithium ion battery in which high speed charge and discharge can be performed without a concern of a significant voltage drop.

As described above, according to the electrode material of the embodiment, the electrode active material particles having the carbonaceous film formed on the surface thereof are aggregated to form an aggregate, the volume density of the aggregate is set to 50% by volume or more and 80% by volume or less of the volume density of a solid body which has the same external appearance as the aggregate, the coverage ratio of the carbonaceous film with respect to the surface of the electrode active material particles is set to 80% or more, and the average thickness of the film is set to 1.0 nm or more and 7.0 nm or less. Accordingly, unevenness in the amount of the carbonaceous film formed on the surface of the electrode active material particles can be reduced and thus, electron conductivity can be improved without deterioration in lithium ion conductivity.

In the present invention, when the electrode material is used for a lithium ion battery, the internal resistance of the battery is reduced by controlling the amount of carbon, the thickness of the carbonaceous film, the density of the carbonaceous film, the specific surface area of the electrode active material particles and the mass percentage of the carbon component in the carbonaceous film, and thus, the lithium ion battery can be used as a high output power supply.

### EXAMPLES

Hereinafter, the present invention will be specifically described referring to Examples 1 to 10 and Comparative Examples 1 to 4. However, the present invention is not limited merely to these embodiments.

For example, in the examples, metal Li is used for a negative electrode to reflect the behavior of the electrode material itself on data. However, a negative electrode material such as a carbon material, a Li alloy, and Li₄Ti₅O₁₂ may be used for a negative electrode. In addition, a solid electrolyte may be used instead of an electrolytic solution and a separator.

### Example 1

(Preparation of Electrode Material)

4 mol of lithium acetate (LiCH₃COO), 2 mol of iron (II) sulfate (FeSO₄), and 2 mol of phosphoric acid (H₃PO₄) were added to 2 L (liters) of water, and water is further added so that the entire amount of the mixture became 4 L, whereby a uniform slurry mixture was prepared.

Then, this mixture was accommodated in an 8-L pressure-resistant airtight container, and hydrothermal synthesis was performed at 120° C. for one hour.

Then, an obtained precipitate was washed with water, whereby a cake-like precursor of the electrode active material was obtained.

Then, 150 g (which is a value converted as a solid content) of the precursor of the electrode active material, an aqueous polyvinyl alcohol solution (2.0% by mass in terms of an amount of carbon, which is obtained by measuring the obtained electrode material using a carbon analyzer), which was obtained by dissolving 20 g of polyvinyl alcohol (PVA) in 100 g of water, as the organic compound, and 500 g of zirconia balls having a diameter of 5 mm as a medium particle were put into a ball mill. Then, a dispersion treatment was carried out such that a stirring time of the ball mill is controlled so that D90/D10 of the particle size distribution of the precursor particles of the electrode active material in the slurry became 7, and a specific surface area of an electrode active material having a carbonaceous film formed on the surface thereof became 5.0 m²/g. At this time, the stirring time of the ball mill was about 30 minutes.

D90 and D10 of the particle size distribution of the precursor particles of the electrode active material were measured such that the ball mill was stopped several times in the middle of the operation to collect samples. Whether or not the specific surface area of the electrode active material particles was 5.0 m²/g was confirmed by a specific surface area meter.

In addition, the reason why the amount of carbon was 2.0% by mass is considered such that a certain degree of carbon content was escaped during the baking, and only a partial amount of the carbon added as PVA was remained in the electrode material.

Next, the obtained slurry was sprayed and dried in the air atmosphere at 180° C. to obtain a dried product having an average particle size of 6 μm.

Next, the obtained dried product was baked at 850° C. in a nitrogen atmosphere for one hour to obtain an aggregate having an average particle size of 6 μm, and this aggregate was used as an electrode material of Example 1. A volume density of the aggregate (the volume density of a solid body which has the same external appearance as the aggregate was set to 100% by volume) was 64% by volume. The volume density was measured using a mercury porosimeter (trade name: PoreMaster GT60, manufactured by Quanta chrome Co.).

(Evaluation of Electrode Material)

The specific surface area of the electrode active material particles of the electrode material, the thickness of the carbonaceous film, the density of the carbonaceous film, the mass fraction of the carbon component (carbon ratio) of the carbonaceous film, and the overage ratio of the carbonaceous film were evaluated, respectively.

Evaluation methods are as follows.

(1) Specific Surface Area of Electrode Active Material Particles

A specific surface area of the electrode active material particles having the carbonaceous film formed on the surface thereof was obtained by measuring the electrode material using a specific surface area meter (trade name: BELSORP-mini II, manufactured by BEL Japan, Inc).

(2) Coverage Ratio of Carbonaceous Film

100 electrode active material particles in the aggregate were randomly selected, and the carbonaceous film thereof was observed using a transmission electron microscope (TEM) and an energy dispersive X-ray spectrometer (EDX) to calculate a ratio of a portion of the surface of the electrode active material particles, which was covered with the carbonaceous film, and thus, the ratio was set to as a coverage rate (average value).

(3) Thickness of Carbonaceous Film

With respect to the carbonaceous film on the surface of the electrode material, 100 electrode active material particles were observed using a transmission electron microscope (TEM) to calculate a thickness (average value) of the carbonaceous film based on a transmission electron microscope (TEM) image.

(4) Density of Carbonaceous Film

100 g of the electrode material was immersed in 2000 cc of an acidic aqueous solution (aqueous hydrochloric acid at a 3N concentration) to perform dissolution, and then, only the carbonaceous film was separated as a residue. Then, the obtained carbonaceous film was dried and the density of the carbonaceous film was measured using a dry type density meter.

(5) Mass Fraction of Carbon Component of Carbonaceous Film (Carbon Ratio)

100 g of the electrode material was immersed in 2000 cc of an acidic aqueous solution (aqueous hydrochloric acid at a 3N concentration) to perform dissolution, and then, only the carbonaceous film was separated as a residue. Then, the separated carbonaceous film was used to measure a carbon ratio of the carbonaceous film using a carbon analyzer.

Evaluation results are shown in Table 1.

(Preparation of Lithium Ion Battery)

The electrode material, polyvinylidene fluoride (PVdF) as a binder, and acetylene black (AB) as a conductive auxiliary agent were mixed in a mass ratio of 90:5:5. 3 g of N-methyl-2-pyrrolidone (NMP) as a solvent was further added to 2 g of the resultant mixture to give flowability, whereby slurry was prepared.

Next, the slurry was applied onto aluminum (Al) foil having a thickness of 15 μm, and was dried. Then, the aluminum foil was pressed at a pressure of 600 kgf/cm², whereby a positive electrode of a lithium ion battery of Example 1 was prepared.

For the positive electrode of the lithium ion battery, a lithium metal was disposed as a negative electrode, and a separator formed from porous polypropylene was disposed between the positive electrode and the negative electrode, and the resultant combination was set as a member for a battery.

On the other hand, ethylene carbonate and diethyl carbonate were mixed in a ratio of 1:1 (mass ratio), and LiPF₆ was further added to the resultant mixture so that the concentration thereof was set to 1 M, whereby an electrolyte having lithium ion conductivity was prepared.

Next, the aforementioned member for a battery was immersed in the electrolyte and stored in a coin cell container, whereby a lithium ion battery of Example 1 was prepared.

(Evaluation of Lithium Ion Battery)

The internal resistance and charge and discharge characteristics of the lithium ion battery were evaluated, respectively.

An evaluation method is as follows.

(1) Charge and Discharge Characteristics

A charge and discharge test of the above-described lithium ion battery was carried out under conditions of room temperature (25° C.), a cut-off voltage of 2 V to 4.5 V, and a constant current at a charge and discharge rate of 1 C (discharge for one hour after charge of one hour). The 1 C discharge capacities are shown in Table 2.

(2) Internal Resistance

The positive electrode and the negative electrode composed of a lithium metal, which had an electrode area of 2 square centimeters, were disposed to face each other with a separator, which was composed of polypropylene, had a thickness of 25 μm and was interposed between the electrodes, in a coin cell container having a diameter of 2 cm and a thickness of 3.2 mm. The internal resistance was calculated based on a 1 C discharge current and a voltage increase, which was measured by a current rest method under the conditions of 1 C discharge and 50% depth of discharge. The internal resistance is shown in Table 2.

### Example 2

An electrode material and a positive electrode of a lithium ion battery of Example 2 were prepared in the same manner as in Example 1 except that the stirring time of the ball mill was adjusted so that a specific surface area of the electrode active material particles daring the carbonaceous film on the surface thereof was 8.1 m²/g, a baking temperature in the nitrogen atmosphere was set to 700° C., and an amount of carbon was set to 1.0% by mass. Then, evaluation was performed. Evaluation results are shown in Tables 1 and 2. The stirring time in Example 2 was about 120 minutes.

Further, the volume density of the aggregate (when the volume density of a solid body which has the same external appearance as the aggregate was 100% by volume) was 62% by volume.

### Example 3

An electrode material and a positive electrode of a lithium ion battery of Example 3 were prepared in the same manner as in Example 1 except that the stirring time of the ball mill was adjusted so that a specific surface area of the electrode active material particles having the carbonaceous film on the surface thereof was 10.7 m²/g, a baking temperature in the nitrogen atmosphere was set to 800° C., and an amount of carbon was set to 1.2% by mass. Then, evaluation was performed. Evaluation results are shown in Tables 1 and 2. The stirring time in Example 3 was about 20 minutes. Further, the volume density of the aggregate (when the volume density of a solid body which has the same external appearance as the aggregate was 100% by volume) was 60% by volume.

### Example 4

An electrode material and a positive electrode of a lithium ion battery of Example 4 were prepared in the same manner as in Example 3 except that the stirring time of the ball mill was adjusted so that a specific surface area of the electrode active material particles having the carbonaceous film on the surface thereof was 12.3 m²/g, a baking temperature in the nitrogen atmosphere was set to 700° C., and an amount of carbon was set to 1.6% by mass. Then, evaluation was performed. Evaluation results are shown in Tables 1 and 2. The stirring time in Example 4 was about 480 minutes. Further, the volume density of the aggregate (when the volume density of a solid body which has the same external appearance as the aggregate was 100% by volume) was 60% by volume.

### Example 5

An electrode material and a positive electrode of a lithium ion battery of Example 5 were prepared in the same manner as in Example 1 except that the stirring time or the ball mill was adjusted so that a specific surface area of the electrode active material particles having the carbonaceous film on the surface thereof was 14.0 m²/g, and an amount of carbon was set to 1.4% by mass. Then, evaluation was performed. Evaluation results are shown in Tables 1 and 2. The stirring time in Example 5 was about 960 minutes. Further, the volume density of the aggregate (when the volume density of a solid body which has the same external appearance as the aggregate was 100% by volume) was 58% by volume.

### Example 6

An electrode material and a positive electrode of a lithium ion battery of Example 6 were prepared in the same manner as in Example 1 except that the stirring time of the ball mill was adjusted so that a specific surface area of the electrode active material particles having the carbonaceous film on the surface thereof was 14.0 m²/g, a baking temperature in the nitrogen atmosphere was set to 900° C., and an amount of carbon was set to 2.0% by mass. Then, evaluation was performed. Evaluation results are shown in Tables 1 and 2. In addition, the stirring time in Example 6 was about 960 minutes. Further, the volume density of the aggregate (when the volume density of a solid body which has the same external appearance as the aggregate was 100% by volume) was 58% by volume.

### Example 7

An electrode material and a positive electrode of a lithium ion battery of Example 7 were prepared in the same manner as in Example 1 except that the stirring time of the ball mill was adjusted so that a specific surface area of the electrode active material particles having the carbonaceous film on the surface thereof was 14.0 m²/g, a baking temperature in the nitrogen atmosphere was set to 950° C., and an amount of carbon was set to 2.0% by mass. Then, evaluation was performed. Evaluation results are shown in Tables 1 and 2. The stirring time in Example 7 was about 960 minutes. Further, the volume density of the aggregate (when the volume density of a solid body which has the same external appearance as the aggregate was 100% by volume) was 58% by volume.

### Example 8

An electrode material and a positive electrode of a lithium ion battery of Example 8 were prepared in the same manner as in Example 1 except that the stirring time of the ball mill was adjusted so that a specific surface area of the electrode active material particles having the carbonaceous film on the surface thereof was 14.0 m²/g, a baking temperature in the nitrogen atmosphere was set to 1000° C., and an amount of carbon was set to 2.0% by mass. Then, evaluation was performed. Evaluation results are shown in Tables 1 and 2. The stirring time in Example 6 was about 960 minutes. Further, the volume density of the aggregate (when the volume density of a solid body which has the same external appearance as the aggregate was 100% by volume) was 58% by volume.

### Example 9

An electrode material and a positive electrode of a lithium ion battery of Example 9 were prepared in the same manner as in Example 1 except that the stirring time of the ball mill was adjusted so that a specific surface area of the electrode active material particles having the carbonaceous film the surface thereof was 14.7 m²/g, a baking temperature in the nitrogen atmosphere was set to 800° C., and an amount of carbon was set to 2.0% by mass. Then, evaluation was performed. Evaluation results are shown in Tables 1 and 2. The stirring time in Example 9 was about 960 minutes. Further, the volume density of the aggregate (when the volume density of a solid body which has the same external appearance as the aggregate was 100% by volume) was 58% by volume.

### Example 10

An electrode material and a positive electrode of a lithium ion battery of Example 10 were prepared in the same manner as in Example 1 except that the stirring time of the ball mill was adjusted so that a specific surface area of the electrode active material particles having the carbonaceous film on the surface thereof was 20.0 m²/g, a baking temperature in the nitrogen atmosphere was set to 700° C., and an amount of carbon was set to 0.6% by mass. Then, evaluation was performed. Evaluation results are shown in Tables 1 and 2. The stirring time in Example 10 was about 440 minutes. Further, the volume density of the aggregate (when the volume density of a solid body which has the same external appearance as the aggregate was 100% by volume) was 55% by volume.

### Comparative Example 1

An electrode material and a positive electrode of a lithium ion battery of Comparative Example 1 were prepared in the same manner as in Example 1 except that the stirring time of the ball mill was adjusted so that a specific surface area of the electrode active material particles having the carbonaceous film on the surface thereof was 17.0 m²/g, a baking temperature in the nitrogen atmosphere was set to 700° C., and an amount of carbon was set to 0.5% by mass. Then, evaluation was performed. Evaluation results are shown in Tables 1 and 2. The stirring time in Comparative Example 1 was about 1200 minutes. Further, the volume density of the aggregate (when the volume density of a solid body which has the same external appearance as the aggregate was 100% by volume) was 56% by volume.

### Comparative Example 2

An electrode material and a positive electrode of a lithium ion. battery of Comparative Example 2 were prepared in the same manner as in Example 1 except that the stirring time of the ball mill was adjusted so that a specific surface area of the electrode active material particles having the carbonaceous film on the surface thereof was 8.5 m²/g, a baking temperature in the nitrogen atmosphere was set to 700° C.,. and an amount of carbon was set to 2.0% by mass. Then, evaluation was performed. Evaluation results are shown in Tables 1 and 2. In addition, the stirring time in Comparative Example 2 was about 130 minutes. Further, the volume density or the aggregate (when the volume density of a solid body which has the same external appearance as the aggregate was 100% by volume) was 62% by volume.

### Comparative Example 3

As electrode material and a positive electrode of a lithium ion battery of Comparative Example 3 were prepared in the same manner as in Example 1 except that the stirring time of the ball mill was adjusted so that a specific surface area of the electrode active material particles having the carbonaceous film on the surface thereof was 4.5 m²/g, a baking temperature in the nitrogen atmosphere was set to 700° C., and an amount of carbon was set to 1.2% by mass. Then, evaluation was performed. Evaluation results are shown in Tables 1 and 2. The stirring time in Comparative Example 31 was about 25 minutes. Further, the volume density of the aggregate (when the volume density of a solid body which has the same external appearance as the aggregate was 100% by volume) was 64% by volume.

### Comparative Example 4

An electrode material and a positive electrode of a lithium ion battery or Comparative Example 4 were prepared in the same manner as in Example 1 except that the stirring time of the ball mill was adjusted so that a specific surface area of the electrode active material particles having the carbonaceous film on the surface thereof was 22.0 m²/g, a baking temperature in the nitrogen atmosphere was set to 700° C., and an amount of carbon was set to 1.0% by mass. Then, evaluation was performed. Evaluation results are shown in Tables 1 and 2. In addition. the stirring time in Comparative Example 4 was about 1600 minutes. Further, the volume density of the aggregate (when the volume density of a solid body which has the same external appearance as the aggregate was 100% by volume) was 52% by volume.

TABLE 1

| | Baking | Specific | Amount | Carbonaceous film | | | |
|---|---|---|---|---|---|---|---|
| | temper- | surface | of carbon | Coverage | | | Carbon |
| | ature | area | (% by | ratio | Thickness | Density | ratio |
| | (° C.) | (m²/g) | mass) | (%) | (nm) | (g/cm³) | (%) |
| Example 1 | 850 | 5.0 | 2.0 | 90 or more | 7.00 | 0.5 | 50 |
| Example 2 | 700 | 8.1 | 1.0 | 90 or more | 4.17 | 0.3 | 50 |
| Example 3 | 800 | 10.7 | 1.2 | 90 or more | 3.81 | 0.4 | 52 |
| Example 4 | 700 | 12.3 | 1.6 | 90 or more | 4.27 | 0.3 | 52 |
| Example 5 | 850 | 14.0 | 1.4 | 90 or more | 3.33 | 0.5 | 55 |
| Example 6 | 900 | 14.0 | 2.0 | 90 or more | 4.76 | 0.8 | 62 |
| Example 7 | 950 | 14.0 | 2.0 | 90 or more | 3.17 | 1.2 | 71 |
| Example 8 | 1000 | 14.0 | 2.0 | 90 or more | 2.53 | 1.5 | 83 |
| Example 9 | 800 | 14.7 | 2.0 | 90 or more | 4.60 | 0.4 | 53 |
| Example 10 | 700 | 20.0 | 0.6 | 90 | 1.00 | 0.3 | 51 |
| Comparative | 700 | 17.0 | 0.5 | 70 | 0.98 | 0.3 | 51 |
| Example 1 | | | | | | | |
| Comparative | 700 | 8.5 | 2.0 | 90 or more | 7.84 | 0.2 | 46 |
| Example 2 | | | | | | | |
| Comparative | 700 | 4.5 | 1.2 | 90 or more | 8.89 | 0.3 | 50 |
| Example 3 | | | | | | | |
| Comparative | 700 | 22.0 | 1.0 | 90 or more | 0.57 | 0.8 | 50 |
| Example 4 | | | | | | | |

TABLE 2

| | 1 C | |
|---|---|---|
| | discharge | Internal |
| | capacity | resistance |
| | (mAh/g) | (Ω) |
| Example 1 | 156 | 12.3 |
| Example 2 | 154 | 11.1 |
| Example 3 | 155 | 10.5 |
| Example 4 | 155 | 10.3 |
| Example 5 | 156 | 11.8 |
| Example 6 | 156 | 9.7 |
| Example 7 | 156 | 10.4 |
| Example 8 | 156 | 12.5 |
| Example 9 | 156 | 10.3 |
| Example 10 | 152 | 12.4 |
| Comparative | 155 | 36.5 |
| Example 1 | | |
| Comparative | 154 | 28.3 |
| Example 2 | | |
| Comparative | 153 | 32.0 |
| Example 3 | | |
| Comparative | 155 | 24.6 |
| Example 4 | | |

According to the results described above, with respect to the electrode materials of Examples 1 to 10, it was found that the thickness of the carbonaceous film was within a range of 1.0 nm to 7.0 nm, the density of the carbonaceous film is within a range of 0.3 g/cm³ to 1.5 g/cm³, and the internal resistance was within a range of 9.5Ω to 12.5Ω. In addition, it was found that these electrode materials had a low internal resistance compared to the electrode materials of Comparative Examples 1 to 4, and can decrease the internal resistance when being used as an electrode material of a lithium ion battery.

### INDUSTRIAL APPLICABILITY

The present invention provides an electrode material, which can improve both electron conductivity and lithium ion conductivity, wherein the density and crystallinity of the carbonaceous film and the thickness of the carbonaceous film are controlled when the electrode active material having the carbonaceous film on the surface thereof is used as an electrode material.

Specifically, in the electrode material of the present invention, the volume density of the aggregate obtained by aggregating the electrode active material particles having the carbonaceous film on the surface thereof is set to 50% by mass or more and 80% by mass or less of the volume density of a solid body which has the same external appearance as the aggregate, and the coverage ratio of the carbonaceous film with respect to the surface of the electrode active material particles is set to 80% or more, and the average thickness of the carbonaceous film is set to 1.0 nm or more and 7.0 nm or less. Thus, unevenness in the amount of the carbonaceous film formed on the surface of the electrode active material particles can be reduced, and farther, the amount or carbon, the thickness of the carbonaceous film, the density of the carbonaceous film, the specific surface area of the electrode active material, and the mass fraction of the carbon component constituting the carbonaceous film can be controlled. When the electrode material is used in a lithium ion battery, the internal resistance of the battery can be reduced and the lithium ion battery can be used for a high output power supply. Accordingly, the electrode material may be applied to a next-generation secondary battery in which further miniaturization, weight-saving and high capacity are expected, and the effects thereof will be very significant when the electrode material is used for the next-generation secondary battery.

1. An electrode material comprising:
an aggregate which is formed by aggregating electrode active material particles having a carbonaceous film formed on the surface thereof,
wherein a volume density of the aggregate is 50% by volume or more and 80% by volume or less of the volume density of a solid body which has the same external appearance as the aggregate,
a coverage ratio of the carbonaceous film with respect to the surface of the electrode active material particles is 80% or more, and
an average thickness of the carbonaceous film is 1.0 nm or more and 7.0 nm or less.

2. The electrode material according to claim 1,
wherein a mass of carbon in the carbonaceous film is 0.6% by mass or more and 2.0% by mass or less with respect to a mass of the electrode active material particles, and
a specific surface area of the electrode active material particles having the carbonaceous film formed on the surface thereof is 5 m²/g or more and 20 m²/g or less.

3. The electrode material according to claim 1,
wherein a mass of a carbon component in the carbonaceous film is 50% by mass or more with respect to a total mass of the carbonaceous film, and
a density of the carbonaceous film obtained from the carbon component in the carbonaceous film is 0.3 g/cm³ or more and 1.5 g/cm³ or less.

4. The electrode material according to claim 1,
wherein the electrode active material particles contain one kind selected from the group consisting of lithium cobaltate, lithium nickelate, lithium manganate, lithium titanate, and LiₓA_{y}D_{z}PO₄, wherein A is one or two or more kinds selected from the group consisting of Co, Mn, Ni, Fe, Cu and Cr, D is one or two or more kinds selected from the group consisting of Mg, Ca, S, Sr, Ba, Ti, Zn, B, Al, Ga, In, Si, Ge, Sc, Y and rare earth elements, 0<x<2, 0<y<1.5, and 0≦z<1.5, as a main component.

5. The electrode material according to claim 1,
wherein an average particle size of the aggregated electrode active material particles is 0.01 μm or more and 20 μm or less.

6. The electrode material according to claim 1,
wherein the carbonaceous film is a carbonaceous film disposed on an electrode active material particle, connects between the electrode active material particles and is generated by thermally decomposing an organic compound, wherein
the carbonaceous film is obtained by; mixing the electrode active material particles or a precursor thereof, water and an organic compound, which is at least one kind selected from the group consisting of polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, dihydric alcohols and trihydric alcohols; spraying and drying the mixture at 70° C. or higher and 250° C. or lower in the air; and then, baking the dried product at 500° C. or higher and 1000° C. or lower in a non-oxidizing atmosphere.

7. An electrode comprising:
an electrode material layer including the electrode material according to claim 1 and a binder resin,
wherein the binder resin is included in a range of 1 part by mass or more and 30 parts by mass or less with respect to 100 parts by mass of the electrode material.

8. The electrode according to claim 7, wherein the electrode is a positive electrode.

9. A battery comprising: the electrode according to claim 7.

10. The battery according to claim 9, wherein the electrode is a positive electrode.
